(19) United States
(12) Patent Application Publication
(10) Pub. No.: US 2004/0245955 A1
(43) Pub. Date: Dec. 9, 2004

(54) Method and apparatus for controlling security gate operation

(76) Inventor: Wayne C. Hom, Rancho Santa Margarita, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/744,490

(22) Filed: Dec. 23, 2003

Related U.S. Application Data
(63) Continuation of application No. 09/932,271, filed on Aug. 16, 2001, now abandoned.

(51) Int. Cl. H02P 1/00; H02P 3/00

(52) U.S. Cl. 318/445; 318/701

(57) ABSTRACT

A security gate operating system and method are disclosed, which may comprise a security gate capable of motion between a closed position and an open position; a drive mechanism attached to the security gate and adapted to provide a driving force to the security gate to move the security gate between the closed position and the open position; and electrical drive motor having a drive shaft connected directly to the drive mechanism without a reduction gear between the drive motor and the drive mechanism. The method and system may also comprise the drive motor being a reluctance motor including a switched reluctance motor, and including also a three phase switched reluctance motor. The method and system may also comprise a drive chain operatively connected to the security gate; and a drive sprocket attached directly to the shaft of the drive motor, with the drive sprocket in operative connection to the drive chain. The method and system may also comprise at least one drive arm directly connected to the drive motor shaft and operatively connected to the security gate.

### FIELD OF THE INVENTION

The present invention relates to the field of security gate operating systems, and more specifically a method and apparatus for simplifying the driving mechanism for a security gate operating mechanism.

### BACKGROUND OF THE INVENTION

It is well known to operate security gates with a motor driven mechanism, and FIG. 1 shows one form of such a security gate system and FIG. 2 shows another form of such a security gate. FIG. 3 shows in more detail the front installation of a drive chain mechanism associated with the form of security gate operating mechanism shown in FIG. 1. FIG. 4 shows another form of security gate chain drive operating mechanism, a so-called rear installation, which is associated with FIG. 2. Typical security gates have a number of advantages, however, when AC or DC motors are utilized to drive them, these gates retain some problems that need to be overcome. For example, it is often the case that environmental conditions may cause the gate to be heavier at times than normally expected, e.g., if snow or ice in on the gate, or debris from a storm is on the gate, or a person is playing on the gate, as for example, hanging on to the gate for a ride. When moving the gate under such conditions a higher initial torque than usual is needed and may cause problems in operation, such as motor overload for typical AC or DC motors. In addition, this required initial torque can limit the size of gate that can be operated with a given size and power capability for a given motor, because of the initial torque requirements. Further, when the gate operating mechanism does malfunction, which can occur from time to time for any number of different reasons, until the gate operating mechanism is put back into service, there will most likely be a need to position the security gate into a desired position to block ingress and egress or to unblock ingress or egress, as may be appropriate. Without the operation of the drive motor, e.g., the prior art security gates can be very difficult to reposition, due, e.g., to the presence of a reduction gear or gearbox that is typically necessary to reduce the high rpm motor speed to a speed of the driving mechanism that is necessary for a safe and controlled operation of the security gate movement. The presence of the reduction gear or gearbox presents a load opposing manual movement of the security gate, which in some cases may not be able to be overcome, or at least may require extensive manual force to be applied to the security gate for movement without the operation of the drive motor. The security gate operating mechanism of the prior art are, therefore, subject to improvement, which is the subject matter of the present invention.

### SUMMARY OF THE INVENTION

A security gate operating system and method are disclosed, which may comprise a security gate capable of motion between a closed position and an open position; a drive mechanism attached to the security gate and adapted to provide a driving force to the security gate to move the security gate between the closed position and the open position; an electrical drive motor having a drive shaft connected directly to the drive mechanism without a reduction gear between the drive motor and the drive mechanism. The method and system may also comprise the drive motor being a reluctance motor including a switched reluctance motor, and including also a three phase switched reluctance motor. The method and system may also comprise a drive chain operatively connected to the security gate; and a drive sprocket attached directly to the shaft of the drive motor, with the drive sprocket in operative connection to the drive chain. The method and system may also comprise at least one drive arm directly connected to the drive motor shaft and operatively connected to the security gate.

### BRIEF DESCRIPTION OF THE DRAWINGS

FIG. 1 (Prior Art) shows a security gate operating system of a type in which the present invention may be utilized;

FIG. 2 (Prior Art) shows another form of a security gate system of a type in which the present invention may be utilized;

FIG. 3 (Prior Art) shows a security gate drive mechanism of the type useful in the security gate operating mechanism of FIG. 1;

FIG. 4 (Prior Art) shows another view of the a security gate drive mechanism of the type useful in the security gate operating mechanism of FIG. 1, with the security gate in a position opposite from that shown in FIG. 3;

FIG. 5 (Prior Art) shows a security gate drive mechanism of the type useful in the security gate operating mechanism of FIG. 2;

FIG. 6 (Prior Art) shows an exploded view of the security gate drive mechanism shown in FIGS. 1, 3 and 4;

FIG. 7 (Prior Art) shows an enlarged view of a portion of the security gate drive mechanism shown in FIGS. 1, 3 and 4;

FIG. 8 shows a perspective view of a security gate operating system according to the present invention; and,

FIG. 9 shows another perspective view of a security gate operating system according to the present invention.

### DETAILED DESCRIPTION OF THE PREFERRED EMBODIMENTS

Turning now to FIG. 1 (Prior Art), there is shown a known form of security gate system 10. The security gate system 10 shown in FIG. 1 is an example of a so-called front installation security gate system 10. The security gate system 10 has a sliding gate 12, which is partially mounted for sliding movement by mounting brackets 14 and 16 to wall sections 18 and 20, respectively. The sliding gate 12 has a pair of rollers 22 that engage a track 24. The gate is driven by a security gate drive mechanism 26, as more fully described in regard to FIG. 3 below. The security gate 12 is driven by a chain drive, more fully described in regard to FIG. 3 between a pair of physical travel stops 28.

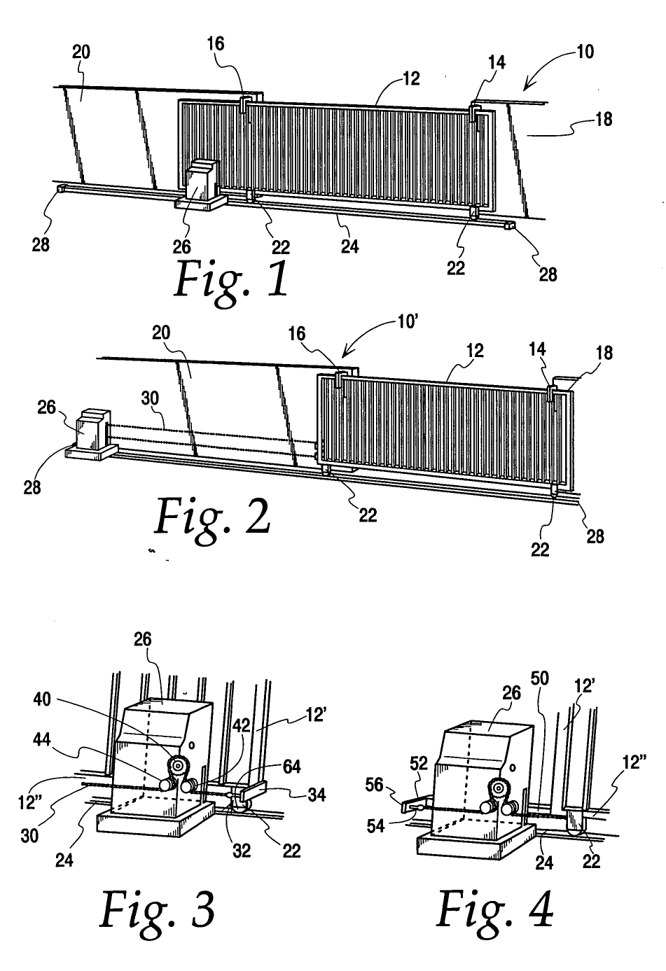

Turning now to FIG. 2 (Prior Art) there is shown another form of security gate system 10′. The security gate system 10′ shown in FIG. 2 is an example of a so-called rear installation security gate system 10′. The security gate system 10′ also has a sliding gate 12, which is partially mounted for sliding movement by mounting brackets 14 and 16 to wall sections 18 and 20, respectively. The sliding gate 12 has a pair of rollers 22 that engage a track 24. The gate is driven by a security gate drive mechanism 26, as more fully described in regard to FIG. 3 below. The security gate 12 is driven by a chain drive, more fully described in regard to FIG. 3 between a pair of physical travel stops 28.

The difference between the security gate system 10 of FIG. 1 and the security gate system 10′ of FIG. 2 is that the chain drive for operating the security gate 12 through movement of chain 30 runs along the bottom of the gate 12 in the embodiment of FIG. 1 and is fully behind the respective wall section 20 in the embodiment of FIG. 2, for added security purposes. The chain 30 is also attached to the security gate 12 and security gate drive mechanism slightly differently as explained in more detail in regard to FIGS. 3 and 4.

Turning now to FIG. 3 (Prior Art) there is shown in more detail a security gate drive mechanism 26 for the embodiment of FIG. 1, as it would appear from a view facing away from the wall section 20 shown in FIG. 1. The security gate drive mechanism has a chain drive sprocket 40, which engages the drive chain 30 after it passes around a first chain guide 42. The chain subsequently passes around a second chain guide 44, as shown in FIG. 3. As also shown in FIG. 3 the chain 30 is attached to the sliding gate 12 by an attachment mechanism 32. The attachment mechanism 32 includes an attachment bar 34, which is attached to the sliding gate 12 as shown in FIG. 3, e.g., by welding the attachment bar 34 to the sliding gate 12 in the position shown in FIG. 3. The attachment mechanism 32 is described in more detail below in regard to FIG. 7.

Turning now to FIG. 4 (Prior Art) there is shown a view of the sliding gate 12 when it is at the opposite end of its travel. The sliding gate 12 is shown in FIG. 4 to be attached to the drive chain 30 by a gate extension arm 50, to which is attached a mounting bar 52, e.g., by welding to the gate extension arm 50. The gate extension arm 50 is itself attached to the sliding gate 12, e.g., by welding the extension arm 50 to the sliding gate 12 in the position as shown in FIG. 4. The drive chain 30 is in turn connected to the mounting bar 52 by a chain attachment mechanism 54, which is held on the mounting bar 52 by a nut 56. The extension arm 50 is cut to a particular size or welded along the lower horizontal portion 12″ of the frame of the sliding gate 12 such that the chain is relatively taught when the sliding gate 12 is at the extent of its travel, as shown in FIG. 4, and thereafter the chain attachment mechanism 32 and 54 can be threaded through the respective attachment bar 34 and/or 52 to fully tighten the chain before engaging the chain to the respective chain attachment mechanism 32 and/or 54.

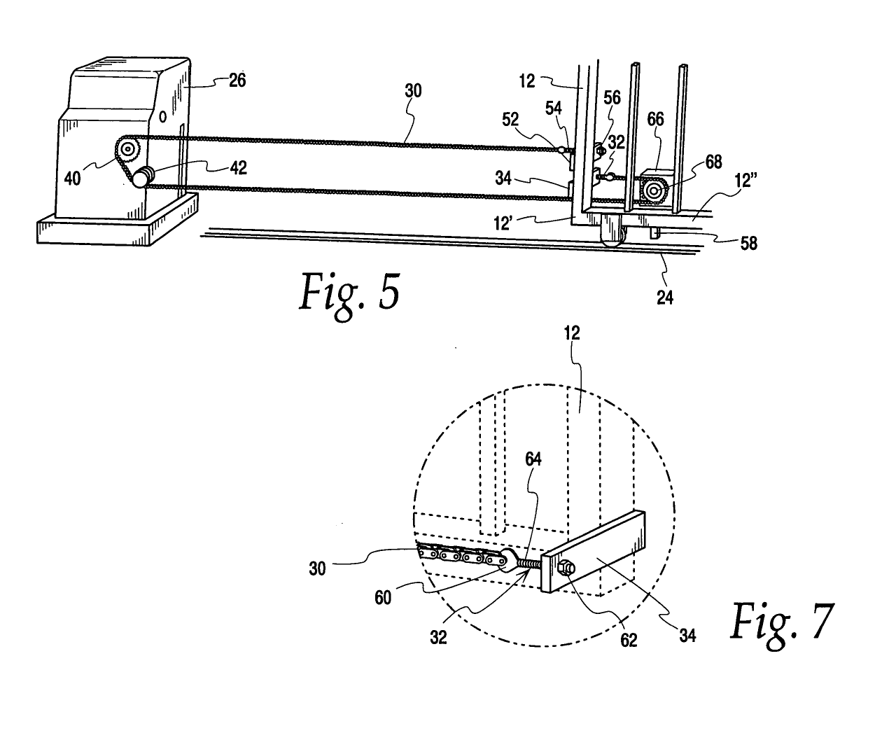

Turning now to FIG. 5 (Prior Art) there is shown a security gate drive mechanism 26 of the type shown in the embodiment of FIG. 2. Here the drive chain 30 passes over the drive sprocket 40 and around only the first pulley 42. One end of the drive chain is attached to the sliding gate by an attachment bar 52, which is attached to the sliding gate 12, as by welding the attachment bar 56 to the sliding gate 12, through an attachment mechanism 54 having a nut 56. The other end of the chain 30 passes around a sprocket 68 rotatably mounted on a sprocket block 66, which is in turn mounted to a sprocket block post 58, e.g., by welding the sprocket block 66 to the sprocket block post 58. The sprocket block post 58 is in turn mounted to the lower horizontal frame member 12″ of the sliding gate 12, as by welding the sprocket block post 58 to the lower horizontal frame member 12″ at such a location that the chain is taught in its extension over the sprocket to the mounting bar 34, to which it is attached by chain attachment mechanism 32.

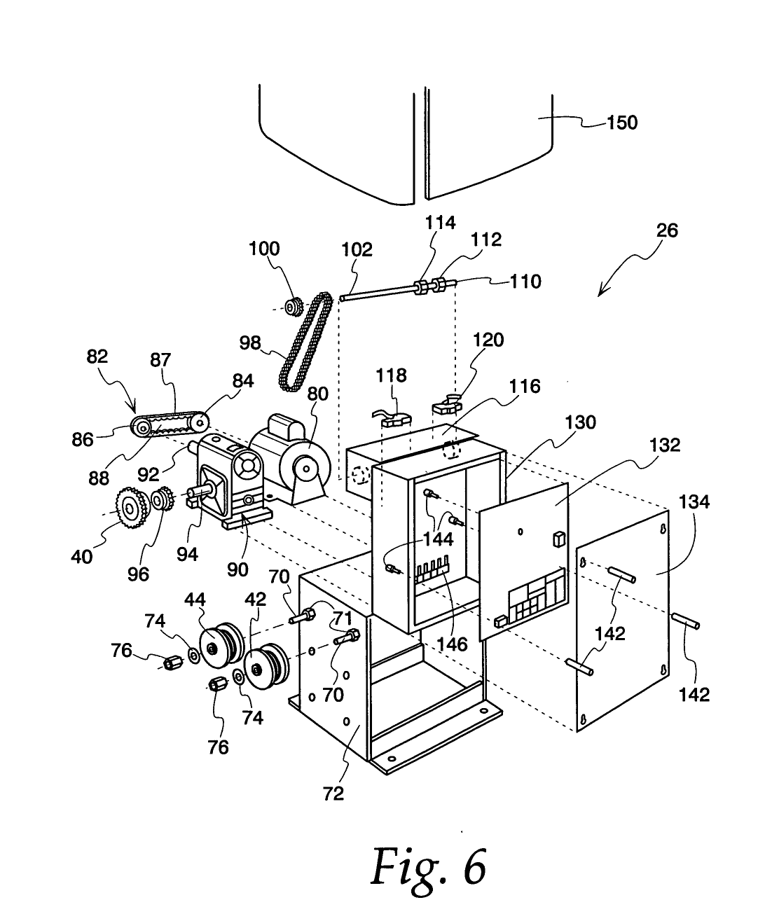

Turning now to FIG. 6 (Prior Art), there is shown an exploded view of a security gate drive mechanism 26, as shown in FIG. 1 or FIG. 2. The security gate drive mechanism 26 has a frame 72. As shown in FIG. 6, the pulley wheels 42, 44, which can be, e.g., slotted UHMW rollers adapted to prevent chain slippage off of the drive sprocket 40, by keeping the drive chain 30 on the chain guide wheels 42, 44 in their respective slots in alignment with the drive sprocket 40 during operation. The drive chain 30 can be, e.g., a # 41 chain. As shown, the pulley wheels 42, 44 are attached to the frame 72 by respective stationary axels 70, each having a threaded end attached to a respective nut 71, which may be attached to the frame 72, as by welding to the frame 72. The respective chain guide wheels 42,44 are held in place on the respective axles 70 by a washer 74 and a capped nut 76.

The security gate drive mechanism of the prior are can include, e.g., a motor 80, which can be, e.g., a one-half horse power instant reversing 120 VAC, 4 amp, 1625 rpm, parking gate motor, such as that made and sold by Leeson, Model No. 100741.50, which can include high speed ball bearings for smoother and quieter operation. In the alternative, the motor 80 can be a permanent magnet 12V DC motor, e.g. that made and sold by Tru-Torq, Model No. 970-535. The motor 80 has a drive shaft, not shown, that connects to a sprocket wheel 84, which is part of a sprocket transfer unit 82. The sprocket transfer unit 82 also has a second sprocket wheel 86, and a chain or a drive belt 87, which extends around the sprocket wheels 84 and 86. The sprocket transfer unit 82 has a typical ratio of 1:1 but the ratio may vary accordingly to match the speed of the motor to the desired speed of the moveable gate. A chain shield 88 covers the sprocket wheels 84 and 86 and the chain 87. The sprocket wheel 86 is attached to an input shaft 92 of a reduction gear 90, which also has an output shaft 94. The reduction gear can be, e.g., a 30-1 worm gear reducer with the gears operating in an oil bath, such as that made and sold by Hampton, Model No. M008. Attached to the output shaft 94 of the reduction gear 90 is the chain drive sprocket 40 and a smaller sprocket 96, internally mounted on the output shaft 94 in relation to the chain drive sprocket 40.

The inner sprocket 96 is connected by a drive chain 98 to a sprocket wheel 100, which is attached to the end of a limit control spindle 102, having threads 110. Moveably mounted on the threads 110 of the motion limit controller spindle 102 is a pair of traveling nuts 112 and 114. The limit controller spindle 102 is rotatably mounted in a motion limit controller housing 116, which is in turn attached to the frame 72. Slideably mounted on the spindle 102 are a pair of adjustably positionable stop members 118 and 120, which are electrically connected to a controller on a circuit board 132 and can provide a signal indicating that the drive chain 30 has reached one end or the other of its extent of desired motion, as by contact of one or the other of the traveling nuts 112 or 114 with its respective stop member 118 or 120.

Also shown in FIG. 6 is a controller circuit board housing 130, which is attached to the frame 72 and in which is contained the controller circuit board 132. A cover 134 is attached to the housing 130 and spacers 142, seat the controller circuit board 132 against input/output electrical signal connections 146 by virtue of being screwed into mounting screws 144, connected to the interior wall of the housing 130.

Turning now to FIG. 7 (Prior Art), there is shown in more detail the connection of the drive chain to the sliding gate, such as in the embodiments of FIGS. 1 and 3. The chain attachment mechanism 32 has a threaded shaft portion 64, which is threaded into nut 62 after passing through a hole in the attachment bar 34. The chain attachment mechanism 32 has a flattened attachment extension 60, to which the chain 30 is attached by passing the pin of the last link of the chain through an opening in the extension 60.

It is also well known in the prior art that the motor 80 of a security gate operating system 10 can come with an internal fan and/or an external fan can in addition be supplied, each of which are in operation whenever the motor 80 is in operation.

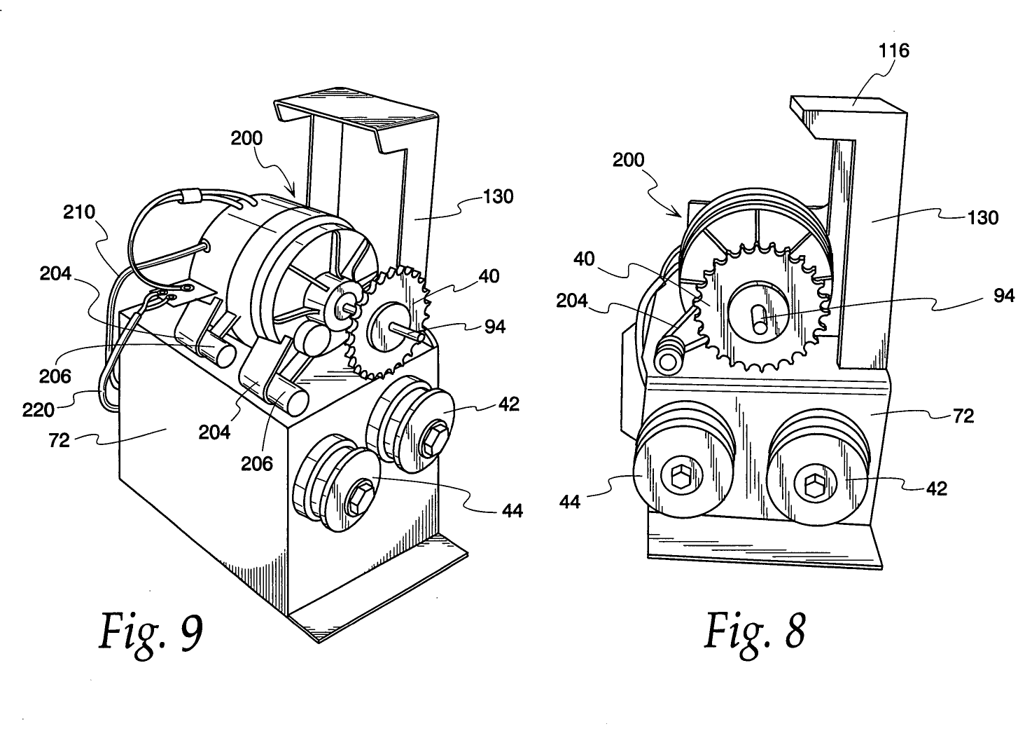

Turning now to FIG. 8 and FIG. 9, there is shown perspective views of a security gate driving mechanism according to the present invention. Mounted on the frame 72 is a switched reluctance motor 200, such as that made for use in industrial sized washing machines, e.g., Neptune washing machines, e.g., one made by Emerson Electric, Model No. M-10816. Such a motor 200 is a type of switched reluctance motor, with the stator and rotor of the motor 200 resembling that of a variable reluctance step motor. Both the stator and rotor (not shown) of the switched reluctance motor 200 have salient poles with phase coils mounted around diametrically opposite stator poles. Power delivered through cables 210 are switched by a controller, not shown, to provide energy to the stator coils of the motor 200 in a fashion that rotates the magnet field through the salient poles of the stator. The rotor will align itself to the magnetic field when diametrically opposed stator pole windings are energized. Some of the rotor poles will be aligned and some will be out of alignment with the remaining unaligned stator poles. When the magnetic field in the stator is stepped/rotated to the next stator pole pair, these will attract the unaligned rotor poles and sequentially continuing to perform this stepping/rotating of the magnetic field will result in the rotor continually moving to try to align itself (“catch up”) to the appropriate minimum reluctance position of the energized stator pole windings, thus the term “switched reluctance.” When the rotor is out of alignment to the minimum reluctance position of the energized stator pole windings, the inductance of the windings is proportionally less than maximum inductance to the misalignment thus allowing more current to flow in the windings and creating higher torque. The attainable torque produced is theoretically limited only by the available energy supplied by the controller. Utilization of such a motor 200 provides for very high starting torque as opposed to AC or DC motors. In addition both speed and torque control are more readily managed through the controller supplying power to the stator windings in an appropriate sequence and with appropriate timing, which also makes for similar control properties in both the opening direction movement of the security gate 10 and the closing direction of the security gate 10. As can be seen from FIG. 8, utilization of a switched reluctance motor 200 also eliminates the need for a reduction gear 90 necessary with AC or DC motors. The drive sprocket 40 can be directly mounted on the shaft 208 of the motor 200, eliminating a number of pieces of machinery from the prior art security gate drive mechanism, in addition to the reduction gear, and making the space needed much smaller and maintenance more simple. The rotor of the motor can be provided with power in a sequence and timing to achieve the torque and speed relationships required to operate a security gate. This type of drive motor 200 can be utilized with other forms of security gate drive mechanism, e.g., rotary arm drive mechanism, with, e.g., the rotary arm or one of a plurality of pivotally attached rotary arms attached directly to the shaft 94 of the motor 200, which, of course, can be mounted with the shaft 94 extending generally vertically. While the preferred embodiments of the present invention have been shown and described, it will be apparent to those skilled in the art that various modifications, in addition to those mentioned above, may be made in these embodiments without departing from the spirit of the present invention. Such modifications, might include the operation of a gate that is hingedly attached for swinging motion between a closed position and an open position, or a gate that is chain driven, but, e.g., opens vertically, as, e.g., a roll-up door commonly used for garage openings and the like. For that reason, the scope of the invention is set forth in the following claims:

I claim:

1. A security gate operating system, comprising:
a security gate capable of motion between a closed position and an open positions; and
a drive mechanism including a reluctance motor having a shaft, connected to the security gate and adapted to provide with application of electric power a driving force to the security gate to move the security gate between the closed position and the open position.

2. The system of claim 1, wherein the motor is switched reluctance motor.

3. The system of claim 1, wherein the motor is a three phase switched reluctance motor.

4. The of claim 1, wherein the drive mechanism further comprises:
a drive chain operatively connected to the security gate;
a drive sprocket attached directly to the shaft of the motor, with the drive sprocket in operative connection to the drive chain.

5. The system of claim 2, wherein the drive mechanism further comprises:
a drive chain operatively connected to the security gate;
a drive sprocket attached directly to the shaft of the motor, with the drive sprocket in operative connection to the drive chain.

6. The system of claim 3, wherein the drive mechanism further comprises:
a drive chain operatively connected to the security gate;
a drive sprocket attached directly to the shaft of the motor, with the drive sprocket in operative connection to the drive chain.

7. The system of claim 1, wherein the drive mechanism further comprises:
at least one drive arm directly connected to the motor shaft and operatively connected to the security gate.

8. The system of claim 2, wherein the drive mechanism further comprises:
at least one drive arm directly connected to the motor shaft and operatively connected to the security gate.

9. The system of claim 3, wherein the drive mechanism further comprises:
at least one drive arm directly connected to the motor shaft and operatively connected to the security gate.

10. A method of operating a security gate, comprising:
providing a security gate capable of motion between a closed position and an open position;
providing a drive mechanism including a reluctance motor, connected to the security gate and adapted to provide with application of electric power a driving force to the security gate to move the security gate between the closed position and the open position; and
applying electric power to the motor to move the security gate.

11. The method of claim 10, wherein the motor is a switched reluctance motor.

12. The method of claim 10, wherein the motor is a three phase switched reluctance motor.

13. A security gate operating system, comprising:
a security gate capable of motion from a closed position to an open position; and
a drive mechanism including a reluctance motor, attached to the security gate and adapted to provide with application of electric power a driving force to the security gate to move the security gate from the closed position to the open position.

14. The system of claim 13, wherein the motor is a switched reluctance motor.

15. The system of claim 31, wherein the motor is a three phase switched reluctance motor.

16. A security gate operating system, comprising:
a security gate means capable of motion between a closed position and an open position; and
a drive mechanism means including a reluctance motor means, connected to the security gate means and adapted to provide with application of electric power a driving force to the security gate means to move the security gate means between the closed position and the open position.

17. The system of claim 16, wherein the motor means is a switch reluctance motor.

18. The system of claim 16, wherein the motor means is a three phase switched reluctance motor.
